(19) United States
(12) Patent Application Publication
(10) Pub. No.: US 2021/0328336 A1
(43) Pub. Date: Oct. 21, 2021

(54) HOUSINGS FOR ELECTRONIC DEVICES

(71) Applicant: Hewlett-Packard Development Company, L.P., Spring, TX (US)

(72) Inventors: Po-Feng Chuang, Taipei City (TW); Kun-Hung Lin, Taipei City (TW); Shih-hua Chang, Taipei City (TW)

(73) Assignee: Hewlett-Packard Development Company, L.P., Spring, TX (US)

(21) Appl. No.: 17/261,894

(22) PCT Filed: Nov. 1, 2018
(86) PCT No.: PCT/US2018/058645

§ 371 Date: Jan. 21, 2021

(51) Int. Cl. H01Q 1/42; G06F 1/16; B29C 70/00; B29C 70/34

(52) U.S. Cl. CPC H01Q 1/422; G06F 1/1656; B29K 2063/00; B29C 70/34; B29C 70/003

(57) ABSTRACT

A housing for an electronic device is described. The housing comprises a molded reinforced plastic, wherein the molded reinforced plastic comprises a woven glass fiber cloth and a single epoxy resin, which is a bisphenol A epoxy resin.

### BACKGROUND

Electronic devices, such as laptops, cell phones, portable GPSes, have many of their electronic components encased within a housing. These devices are frequently subjected to mechanical deformation when they are placed in contact with other objects, such as a person's hand, a table or the ground. The housings that form the electronic devices should be able to tolerate such mechanical deformation and withstand wear and tear from regular use.

These electronic devices also have antennas for transmitting and receiving radio waves. The antenna may be encased with the housing for protection.

### BRIEF DESCRIPTION OF THE DRAWINGS

FIGS. 1 and 2 are a schematic illustration of a method of manufacturing a housing for an electronic device according to an example of the present disclosure.

FIG. 3 is a simplified partial cross section through an electronic device, which is provided for illustrative purposes.

FIG. 4 is a simplified partial cross section through an electronic device according to an example of the present disclosure.

The figures depict several examples of the present disclosure. However, it should be understood that the present disclosure is not limited to the examples depicted in the figures

### DETAILED DESCRIPTION

As used in the present disclosure, the term “about” is used to provide flexibility to an endpoint of a numerical range. The degree of flexibility of this term can be dictated by the particular variable and is determined based on the associated description herein.

Amounts and other numerical data may be expressed or presented herein in a range format. It is to be understood that such a range format is used merely for convenience and brevity and thus should be interpreted flexibly to include not just the numerical values explicitly recited as the limits of the range, but also to include individual numerical values or sub-ranges encompassed within that range as if each numerical value and sub-range is explicitly recited.

As used in the present disclosure, the term “single” when used to describe the quantity of a certain feature has a closed meaning, such that only one of that feature can be present.

As used in the present disclosure, the term “non-conductive” refers to a feature that is not electrically conductive.

As used in the present disclosure, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

It is noted that, as used in this specification and the appended claims, the singular forms “a”, “an” and “the” include plural referents unless the context clearly dictates otherwise.

The present disclosure refers herein to a housing for an electronic device, to a method of manufacturing a housing and to an electronic device.

The housing comprises a molded reinforced plastic. The molded reinforced plastic comprises a woven glass fiber cloth and a single epoxy resin. The epoxy resin is a bisphenol A epoxy resin.

The electronic device comprises an antenna located within the housing of the electronic device.

The method of manufacturing the housing for an electronic device, comprises: applying a liquid comprising an epoxy resin to a woven glass fiber cloth to produce a resin-containing cloth, wherein the epoxy resin is bisphenol A epoxy resin; placing the resin-containing cloth into a mold cavity for forming the housing; compressing a surface of the resin-containing cloth to remove air pockets within the resin-containing cloth; and compacting and heating the resin-containing cloth within the mold cavity to cure the bisphenol A epoxy resin.

It is to be understood that this disclosure is not limited to the housings, electronic devices or methods disclosed herein. It is also to be understood that the terminology used in this disclosure is used for describing particular examples. The terms are not intended to be limiting because the scope of the present disclosure is intended to be limited by the appended claims and equivalents thereof.

### Woven Glass Fiber Cloth

The molded reinforced plastic comprises a woven glass fiber cloth, such as an interwoven sheet of glass fibers. The presence of a woven cloth within the plastic reinforces the structure of the overall material. The properties of the glass fiber cloth affect the properties of the resulting molded reinforced plastic, such as its weight and strength.

The woven glass fiber cloth may have a thickness of about 0.015 mm to about 0.185 mm, such as from about 0.019 mm to about 0.075 mm or about 0.081 to about 0.185 mm.

The weight of the woven glass fiber cloth may be from about 15.0 g/m² to about 240 g/m², such as from about 20 g/m² to about 230 g/m². In one example, the weight of the woven glass fiber cloth may be from about 16.5 g/m² to about 150 g/m² or from about 160 g/m² to about 235 g/m².

The glass fiber cloth may have a warp count of about 40 per inch to about 96 per inch, such as about 40 per inch to about 60 per inch or about 65 per inch to about 90 per inch.

The glass fiber cloth may have a weft count of about 30 per inch to about 96 per inch, such as about 35 per inch to about 60 per inch or about 65 per inch to about 90 per inch.

In one example, the glass fiber cloth has a weft count that is within ±30% of the warp count, such as ±20% of the warp count or ±10% of the warp count.

The warp and weft properties of the woven glass fiber can affect the durability of the resulting molded reinforced plastic.

The glass fiber cloth is a woven cloth, which may comprise glass fibers in both a warp direction and a weave direction. The same material may be used in the warp and weave directions.

The woven cloth may comprise yarns in a warp direction and a weave direction, wherein each yarn comprises at least one glass fiber.

The glass fibers may have a composition comprising silicon oxide (SiO₂) and aluminum oxide (Al₂O₃). The composition may comprise at least one of boric oxide (B₂O₃), calcium oxide (CaO) and magnesium oxide (MgO).

In one example, the glass fiber cloth only comprises non-conductive fibers, such as fibers that consist of glass. Examples of conductive fibers include carbon fibers, graphite fibers, and aluminum fibers. Such fibers may not be present in the glass fiber cloth of the present disclosure.

In another example, the molded reinforced plastic comprises a single layer of the woven glass fiber cloth. The single layer may be provided by a single sheet of the woven glass fiber cloth, such as when it is unfolded. In the method of manufacturing the housing, a single, unfolded sheet of the resin-containing cloth may be placed into a mold cavity. This single, unfolded sheet will form a single layer in the molded reinforced plastic.

In another example, the molded reinforced plastic comprises a plurality of layers of the woven glass fiber cloth. The plurality of layers may be provided by (i) a plurality of sheets of the woven glass fiber cloth, such as when the sheets are stacked on top of one another, and/or (ii) one or more folds of a sheet of the woven glass fiber cloth. For example, a sheet of the woven glass fiber cloth can be folded back on itself one or more times within the mold cavity.

### Epoxy Resin

The molded reinforced plastic comprises an epoxy resin, which is a bisphenol A epoxy resin. The epoxy resin forms a matrix that is reinforced by the woven glass fiber cloth.

The bisphenol A epoxy resin can be a liquid at room temperature, which is about 20° C.

The bisphenol A epoxy resin may be obtained by (i) reacting bisphenol A with an epichlorohydrin, or (ii) adding an amount of bisphenol A to a liquid epoxy resin, and then adding a catalyst and heating the reaction up to about 160° C.

The bisphenol A epoxy resin may have an epoxy equivalent weight (FEW) of from about 175 to about 900 g/equivalent (eq). The EEW is the weight of the resin in grams that contains a one gram-equivalent of epoxy. In one example, the bisphenol A epoxy resin has an EEW of from about 175 to about 350 g/eq, such as from about 180 to about 275 g/eq. In another example, the bisphenol A epoxy resin has an EEW of from about 450 to about 900 g/eq, such as from about 575 to about 850 g/eq.

In one example, the bisphenol A epoxy resin has a number average molecular weight of <700 g/mol.

The bisphenol A epoxy resin may have a flash point of > about 250° C.

The bisphenol A epoxy resin may be is a thermosetting resin, such as a cured thermosetting resin. During use, electrical components of the electronic device may become hot. Unlike thermoplastic resins, a thermosetting resin does not melt when heated and will remain intact when hot electrical components are positioned nearby.

In the present disclosure, the molded reinforced plastic may comprise a single epoxy resin. Thus, only one type of epoxy resin may be present in the molded reinforced plastic. A housing can be made from a molded reinforced plastic, which can be obtained from a single epoxy resin using a convenient, low cost method of manufacture, as described in the present disclosure.

### Reinforced Plastic

The reinforced plastic in the present disclosure may be molded, for example, into the shape of the housing for the electronic device.

The molded reinforced plastic may be non-conductive. Thus, the molded reinforced plastic may not comprise a conductive material. The presence of a conductive material can affect the performance of the antenna of the electronic device.

At least 50% wt. of the molded reinforced plastic is the woven glass fiber cloth and the epoxy resin. For example, at least 70% wt. or at least 90% wt. of the molded reinforced plastic is the woven glass fiber cloth and the epoxy resin.

In one example, the molded reinforced plastic comprises a fire retardant. The fire retardant may be selected from a phosphorus-containing compound, a nitrogen-containing compound and a silicone resin.

The phosphorus-containing compound may, for example, be a phosphate ester, a phosphaphenanthrene compound or red phosphorus. Examples of suitable phosphate esters include trimethylphosphate, triethylphosphate, tributylphosphate, tri(2-ethylhexyl)phosphate, tributoxyethylphosphate, triphenylphosphate, tricresylphosphate, trixylenylphosphate, tris-(isopropyl phenyl)phosphate, tris-(phenyl phenyl)phosphate, trinaphthylphosphate, cresyldiphenylphosphate, xylenyldiphenylphosphate, diphenyl(2-ethylhexyl)phosphate, di(isopropylphenyl)phenylphosphate, monoisodecylphosphate, 2-acryloyloxyethylacid phosphate, 2-methacryloyloxyethyl acid phosphate, diphenyl-2-acryloyloxyethylphosphate, diphenyl-2-methacryloyloxyethylphosphate, melaminephosphate, dimelaminephosphate, melaminepyrophosphate, triphenylphosphine oxide, tricresyl phosphine oxide, methanephosphonate acid diphenyl, phenylphosphonic acid diethyl, resorcinolpolyphenylphosphate, resorcinolpoly(di-2,6-xylyl)phosphate, bisphenol A polycresyl phosphate and hydroquinone poly(2,6-xylyl)phosphate.

The nitrogen-containing compound may, for example, be melamine cyanurate, melamine sulfate or guanidine sulfamate.

When the molded reinforced plastic comprises a fire retardant, then the fire retardant may be present in an amount of up to 10% wt of the molded reinforced plastic, such as 0.1 to 5% wt.

The molded reinforced plastic may comprise inorganic particles, such as powder silica; an elastomer; or a defoaming agent.

A curing agent for the epoxy resin, such as described herein, may be present in the molded reinforced plastic. The curing agent from the curing reaction may remain trapped within the molded reinforced plastic.

In one example, the molded reinforced plastic comprises a single polymeric resin, which is the epoxy resin. Thus, the molded reinforced plastic may not comprise a second resin, such as a polymeric resin.

### Housing

In the present disclosure, the housing comprises a molded reinforced plastic. The housing may be obtained from the method of manufacturing a housing in the present disclosure.

A housing made from the molded reinforced plastic described herein can be light-weight, durable and it can withstand the mechanical stresses when tested, for example, using compression, torsion and twist tests. The housing is strong enough to survive a drop test, such that the electronic device and its internal, electronic components remain intact. The molded reinforced plastic of the housing also does not affect the performance of the electronic device's antenna.

The housing is for an electronic device that may have an antenna, such as a radio frequency (RF) antenna. When the electronic device has an antenna, then the antenna may be located or encased within the housing. The housing may be external to the antenna. The housing may also be external to an electrical circuit, such as a motherboard or the display circuitry, of the electronic device. The housing may also include a battery cover area, a battery door or a vent.

The housing may provide an exterior part of the electronic device, such as the cover or base casing of the electronic device. The housing may include a support structure for an electronic component of the electronic device, such as a support structure for an antenna.

The housing may provide substantially all of the cover or the base casing of the electronic device. The term “substantially all” in this context refers to at least 90%, such as at least 95% or at least 99%, of the total weight of the cover or the base casing. The housing may provide the entire cover or base casing of the electronic device.

The use of a single structural material for the cover or the base casing of an electronic device avoids the complexity associated with manufacturing a cover or base casing from multiple parts. When a single material is used, the cover or base casing has an attractive and uniform appearance, and it avoids structural weaknesses that may arise from assembling the cover or the base casing from multiple component parts. As the cover or base casing is made from the molded reinforced plastic, it does not affect the performance of the antenna, unlike covers or base casings that incorporate metallic components.

The housing can be the cover, such as a lid, the base casing or both the cover and the base casing of the electronic device. The base casing may be the bottom cover of the electronic device. In one example, the housing is the base casing of a laptop, a tablet or a cell phone.

The housing may comprise a coating layer. The coating may be disposed on or incorporated within the molded reinforced plastic. The molded reinforced plastic may be coated to improve its appearance.

When the housing comprises a coating layer, then the coating layer may comprise a paint, such as a radio frequency transparent paint, or a non-conductive ceramic.

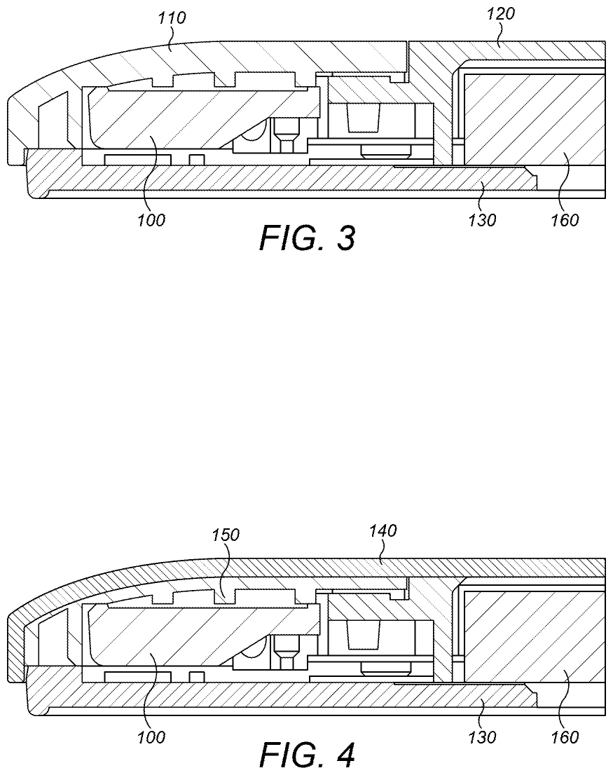

An example of a housing 140 of the present disclosure is shown in FIG. 4. This figure shows a partial cross-section through a laptop. The laptop has an

RF antenna 100, a bezel 130 and an LCD panel 160. The laptop has a housing 140 made of a molded reinforced plastic according to the present disclosure. The housing forms the entire base casing of the laptop. The RF antenna 100 is held within an inner frame 150, which may or may not be integral with the base of the laptop.

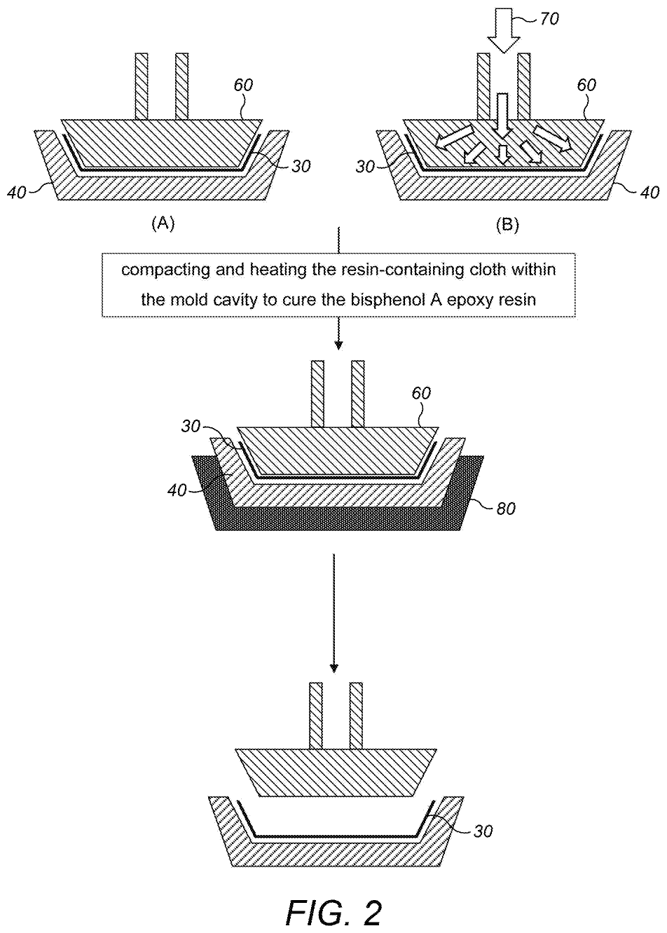

An illustrative example of a housing that may not be part of the present disclosure is shown in FIG. 3. This figure also shows a partial cross-section through a laptop. The laptop has an RF antenna 100, a bezel 130 and an LCD panel 160. The housing is a base casing, which is made up of at least two component parts. These parts are a plastic antenna window 110 and an aluminum cover 120.

### Method

The present disclosure provides a method of manufacturing a housing for an electronic device. The manufacturing method is a simple, cost effective method and can be used to prepare the entire housing of an electronic device in the form of a single, shaped part.

The method comprises applying a liquid comprising an epoxy resin to a woven glass fiber cloth to produce a resin-containing cloth. The epoxy resin is the bisphenol A epoxy resin described herein. The bisphenol A epoxy resin is a liquid at room temperature (about 20° C.).

The liquid that may be used to produce the resin-containing cloth may comprise at least one of a curing agent and a fire retardant, such as described herein.

The liquid may comprise inorganic particles, such as powder silica; an elastomer; or a defoaming agent.

The curing agent may be a thermally activated curing agent to ensure stability during preparation at room temperature. A thermally activated curing agent does not have substantial activity at room temperature and has activity when heated to a temperature above room temperature.

The curing agent may be an organo-nitrogen based curing agent. An organo-nitrogen based curing agent refers to a compound that comprises a nitrogen-based functional group, such as an amino group, an amide group, an imidazole group, a urea group, or a hydrazide group, which group can cure the epoxy resin. Examples of types of organo-nitrogen based curing agents include an aromatic amine, an aliphatic amine, a tertiary amine, a secondary amine, imidazole, a urea derivative, a carboxylic acid hydrazide, a dicyandiamide, or tetramethyl guanidine.

In one example, the liquid that is used to produce the resin-containing cloth may comprise a single epoxy resin. The liquid does not comprise a second resin, such as a polymeric resin, which may, for example, be a polycarbonate resin, a polyester resin, a polyolefin resin, or a styrene resin.

The liquid may be applied to the woven glass fiber cloth by immersing or soaking the woven glass fiber cloth in the liquid, such as in a container comprising the liquid. In one example, the container is not the mold cavity. The container is a different vessel to the mold cavity.

A resin-containing cloth may be obtained after the liquid comprising an epoxy resin is applied to the woven glass fiber cloth. The resin-containing cloth contains resin located between the warps and weaves of the woven cloth. The resin-containing cloth may also be known as a resin-impregnated cloth.

The method then comprises placing the resin-containing cloth into a mold cavity for forming the housing. The mold cavity may be shaped to form the housing from the resin-containing cloth. The mold cavity may be shaped to form at least one of an internal surface and an external surface of the housing, such as the main flat surface of the cover or base casing of the electronic device.

The resin-containing cloth can be molded into a housing. The housing can be formed from a single piece of the molded reinforced plastic. It is not, for example, necessary to include a step of cutting the molded reinforced plastic into the shape of the housing in the method of the present disclosure.

In one example, the resin-containing cloth may be folded within the mold cavity or placed in a folded arrangement into the mold cavity. When the resin-containing cloth is folded in the mold cavity, then the molded reinforced plastic may comprise a plurality of layers of the woven glass fiber cloth. The resin-containing cloth may be folded to achieve a desired thickness of the housing.

In another example, a plurality of resin-containing cloths may be placed into the mold cavity for forming the housing. A first resin-containing cloth may be disposed on top of a second resin-containing cloth within the mold cavity. The resin-containing cloths may be stacked on top of one another. When a plurality of resin-containing cloths is placed into the mold cavity, then the molded reinforced plastic may comprise a plurality of layers of the woven glass fiber cloth. The number of resin-containing cloths that are placed into the mold cavity depends on the thickness of the housing that is to be manufactured.

Once a resin-containing cloth or a plurality of resin-containing cloths has been placed into the mold cavity, a surface of a resin-containing cloth is compressed. When there is a plurality of resin-containing cloths, then a top-most surface of a resin-containing cloth may be compressed.

The compressing is, for example, performed to remove air pockets from within the resin-containing cloth or the plurality of resin-containing cloths. It may also uniformly distribute the epoxy resin. If air pockets are not removed and the epoxy resin is not uniformly distributed, then the resulting molded reinforced plastic may contain defects or anomalies that can weaken the structure of the housing.

To compress the cloth, a roller may be passed or rolled over a surface of the resin-containing cloth. This is to remove air pockets from within the resin-containing cloth and it may also uniformly distribute the epoxy resin. The roller may be rolled or passed over the surface when the resin-containing cloth is within the mold cavity.

The resin-containing cloth is then compacted and heated within the mold cavity. The compacting and/or the heating is performed to cure the bisphenol A epoxy resin. By compacting the resin-containing cloth, the cloth is molded into the shape of the housing, which is determined by the shape of the mold cavity and the mold core. Some curing of the epoxy resin may also occur. Heating the epoxy resin may bring about curing of the resin.

In one example, the compacting and heating can be started and performed at the same time.

In another example, the compacting and heating are started sequentially. The compacting may be started before the heating. The compacting and heating may then be performed together.

The resin-containing cloth may be compacted using a mold core. The mold core may be shaped to form at least one of an internal surface and an external surface of the housing.

In one example, the resin-containing cloth may be compacted using pressurized gas. Pressurized gas may be passed through the mold core onto the surface of the resin-containing cloth.

The resin-containing cloth may be heated to a temperature from about 150° C. to about 250° C., such as from about 160° C. to about 240° C. In one example, the resin-containing cloth is heated to a temperature of from about 180° C. to about 220° C.

In method of the present disclosure, the molding of the resin-containing cloth by compacting and heating may be performed for a total time of from about 30 min to about 60 min. Shorter molding times may be used when the liquid comprises a curing agent.

When compacting the resin-containing cloth, a pressure of from about 0.1 to about 1 MPa may be applied to the cloth.

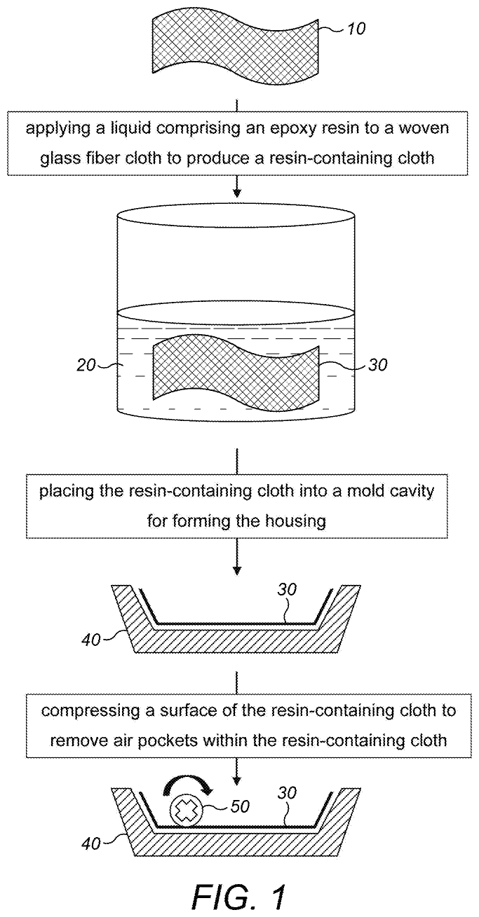

An example of the method of the present disclosure is shown in FIGS. 1 and 2. For simplicity, the method shown in these figures involves the use of a single woven glass fiber cloth 10 and a single resin-containing cloth 30. It is, however, to be understood that multiple woven glass fiber cloths or multiple resin-containing cloths may be used in each step of the method.

In FIG. 1, a woven glass fiber cloth 10 is immersed in a liquid 20 held within a container, which comprises an epoxy resin. The resulting resin-containing cloth is then removed from the container and is placed into a mold cavity 40.

A surface of the resin-containing cloth 30 is then compressed to remove air pockets from within the cloth by passing a roller 50 over its surface.

FIG. 2 shows a mold core 60 being used to compress the resin-containing cloth 30 within the mold cavity 40. In (A) compression is applied by using only the mold core 60, which is pushed into the mold cavity 40 to compact the resin-containing cloth 30. In (B) a combination of pressurized air 70 that is blown through the mold core 60 and the action of pushing the mold core 60 into the mold cavity 40 compacts the resin-containing cloth 30.

With the mold core 60 in place within the mold cavity 30, a heating element 80 is used to heat the resin-containing cloth 30 to cure the epoxy resin and form a molded reinforced plastic.

Once the curing process is complete, the heating element 80 and the mold core 60 may be removed from the mold cavity 40. A housing comprising a molded reinforced plastic may then be removed from the mold cavity 40.

### Electronic Device

The electronic device comprises an antenna, such as a radio frequency (RF) antenna, located within the housing. To be able to receive and transmit, signals may have to pass through the housing to the antenna. The housing of the present disclosure does not affect the transmission or reception of signals by the antenna.

The electronic device may be a computer, a cell phone, a portable networking device, a portable gaming device or a portable GPS. The computer may be portable. When the computer is portable, it may be a laptop or a tablet.

In some countries, cell phones are referred to as mobile phones and portable GPSs are referred to as portable Sat Nays.

When the housing provides the base casing of the electronic device, the base casing may have a compartment or a support structure for the antenna.

### EXAMPLES

The present disclosure will now be illustrated by the following non-limiting example.

### Example 1

A woven glass fiber cloth having a warp count of 40 per inch and a weft count of 39 per inch was soaked in a liquid comprising a bisphenol A epoxy resin. The resulting resin-containing cloth was placed in a mold cavity of a mold. The mold cavity was shaped to form a base casing of a laptop. Several layers of the resin-containing cloth were placed within the mold cavity to achieve the intended thickness of the base casing for the laptop.

To remove air pockets and to distribute the epoxy resin uniformly, a roller was pressed and passed over the surface of the top most resin-containing layer within the mold cavity.

The layers of resin-containing cloth were compressed using a mold core. The mold core was shaped to provide the internal features of the base casing for the laptop. While the mold core was pressing against the layers of the resin-containing cloth, the mold cavity was heated to cure the epoxy resin. Based on the desired thickness of the housing, a mold time of 1 to 1.5 hours was used.

After curing, the mold cavity was allowed to cool to room temperature and then the mold core was lifted out of the mold cavity. A base casing comprising a molded reinforced plastic was then removed from the mold cavity.

1. A housing for an electronic device comprising a molded reinforced plastic, wherein the molded reinforced plastic comprises a woven glass fiber cloth and a single epoxy resin, which is a bisphenol A epoxy resin.

2. The housing of claim 1, wherein the woven glass fiber cloth comprises a woven cloth having glass fibers in both a warp direction and a weave direction.

3. The housing of claim 1, wherein the molded reinforced plastic comprises a fire retardant.

4. A method of manufacturing a housing for an electronic device, comprising:
applying a liquid comprising an epoxy resin to a woven glass fiber cloth to produce a resin-containing cloth, wherein the epoxy resin is bisphenol A epoxy resin;
placing the resin-containing cloth into a mold cavity for forming the housing;
compressing a surface of the resin-containing cloth to remove air pockets within the resin-containing cloth; and
compacting and heating the resin-containing cloth within the mold cavity to cure the bisphenol A epoxy resin.

5. The method of claim 4, wherein the liquid comprises a single epoxy resin, which is the bisphenol A epoxy resin.

6. The method of claim 4, wherein the liquid is applied to the woven glass fiber cloth by immersing or soaking the woven glass fiber cloth in a container comprising the liquid.

7. The method of claim 4, wherein the liquid comprises a curing agent.

8. The method of claim 4, wherein the surface of the resin-containing cloth is compressed by passing a roller over the surface of the resin-containing cloth to remove air pockets within the resin-containing cloth.

9. The method of claim 4, wherein the resin-containing cloth is compacted within the mold cavity using a mold core.

10. The method of claim 9, wherein the compacting the resin-containing cloth includes passing pressurized gas through the mold core onto the surface of the resin-containing cloth.

11. The method of claim 4, wherein a plurality of resin-containing cloths is placed into a mold cavity for forming the housing, wherein a first resin-containing cloth is disposed on top of a second resin-containing cloth within the mold cavity.

12. The method of claim 11, wherein the compressing a surface of the resin-containing cloth includes compressing a top-most surface of a resin-containing cloth to remove air pockets within the plurality of resin-containing cloths.

13. The method of claim 11, wherein the compacting and heating the resin-containing cloth includes compacting and heating the plurality of resin-containing cloths within the mold cavity to cure the bisphenol A epoxy resin.

14. An electronic device comprising an antenna located within a housing of the electronic device, wherein the housing comprises a molded reinforced plastic comprising a woven glass fiber cloth and a single epoxy resin, which is a bisphenol A epoxy resin.

15. The electronic device of claim 14, wherein the housing is a base or a lid of the electronic device.
